(19) United States
(12) Patent Application Publication
(10) Pub. No.: US 2015/0083103 A1
(43) Pub. Date: Mar. 26, 2015

(54) DEVICE FOR CUTTING GRANITE OR OTHER HARD MATERIALS

(71) Applicant: Robert CALAS, NAVES (FR)

(72) Inventor: Robert CALAS, NAVES (FR)

(73) Assignee: CALAS PRODUCTION, Labruguiere (FR)

(21) Appl. No.: 14/493,874

(22) Filed: Sep. 23, 2014

(30) Foreign Application Priority Data
Sep. 24, 2013 (FR) 13 59168

(51) Int. Cl. B28D 1/00; B28D 7/04; B28D 1/06; B28D 1/04

(52) U.S. Cl. CPC B28D 1/003; B28D 1/043; B28D 7/046; B28D 1/06
USPC 125/14

(57) ABSTRACT

A device for cutting granite or other hard materials includes a cutter disc (6) for making cut-outs of rectilinear or curved shape. The device includes a machining head (5) simultaneously carrying the cutter disc (6) and jigsaw elements (7) for making cuts in closed corners. The device may further include manipulator sucker elements (8) for moving parts to be cut or parts to be cut out.

### FIELD OF THE INVENTION

The invention relates to a device for cutting granite or other hard materials, of the type including a cutter disc for making cut-outs of rectilinear or curved shape.

### BACKGROUND OF THE INVENTION

The document WO 2005/014252 A1 describes a cutting device for cutting marble, granite, glass or similar sheets, including numerical control means for a disc cutter head movable in a cutting volume and including means for manipulating said sheets in said cutting volume.

The means for manipulating said sheets include at least one manipulator member extending from the cutter head. Said manipulating means are disposed to cooperate with the sheet being cut and include suckers.

Cutter discs for making cut-outs of rectilinear shape have been known for a long time and are usually controlled by numerical control means to cut out required shapes.

However, the shape of the cut-out must take account of the dimensions of the cutter disc and its movement possibilities.

Moreover, in the case of granite or other hard materials having a low resistance to friction, some cut-out shapes necessitate previous reinforcement by bonding a rigid material of the steel or equivalent kind in longitudinal grooves generally made in the lower face of the cut-out shape.

To avoid turning the part over and the risk of the part breaking when turning it over, it is known to move the machining head to groove the lower face of the part to be cut out, thereby preventing the risk of breaking it caused by turning it over.

The document US 2011/0283859 A1 describes a cutting machine and manipulator means incorporated in it. This cutting machine includes a cutter disc the protective casing of which carries manipulator suckers for moving cut-out parts.

The assembly including the cutter disc referred to as the “cutter disc assembly” therefore pivots 90° between a cutting position and a manipulation position.

An additional tool may be mounted coaxially with the cutter disc, but this additional mounting then prevents the manipulator suckers from working.

### SUMMARY OF THE INVENTION

A first object of the invention is to improve on the prior art by proposing a new device for cutting granite or other hard materials with increased productivity and enabling wastage of materials to be reduced and cutting closed contours inside existing parts to be simplified.

A second object of the invention is to enable manipulation of parts to be cut or parts to be cut out without modifying the cutting means, thereby allowing the mounting of supplementary tools without preventing manipulation of the parts to be cut or the parts to be cut out.

The invention consists in a device for cutting granite or other hard materials, of the type including a cutter disc for making cut-outs of rectilinear or curved shape, characterized in that the device includes a machining head simultaneously carrying said cutter disc and jigsaw means for making cuts in closed corners.

Accordingly, to cut out a closed contour opening in an existing part, it suffices to use the cutter disc to cut out the greater part of the rectilinear sides and to finish cutting the corners using the jigsaw means.

This feature makes it possible to make a closed contour opening in a part already cut out without transporting the part to another machine.

According to other alternative features of the invention:
The device may include manipulator sucker means for moving parts to be cut or parts to be cut out.
The jigsaw means preferably include a saw blade with a diamond coating.
The manipulator sucker means are preferably movable between a first or lateral stowed position and a second or manipulation position.
The manipulator sucker means advantageously include a plurality of suckers mounted on a common support.
The common support of the plurality of suckers is advantageously mounted laterally at a distance from and above the protective casing of the cutter disc.
The jigsaw means include a sliding member guided on two columns and carrying the means for driving the jigsaw.
The common support of the plurality of suckers is mounted on a frame removably connected to the support of the cutter disc assembly.
The cutter disc assembly and the jigsaw means are mounted laterally on either side of a machining head.

The invention also relates to a numerically controlled machine having a plurality of movement axes and including a device in accordance with the invention.

### BRIEF DESCRIPTION OF THE DRAWINGS

The invention will be better understood thanks to the following description given by way of nonlimiting example with reference to the appended drawings, in which:

FIG. 1 represents diagrammatically a perspective view of a numerically controlled machine according to the invention with a plurality of movement axes.

FIG. 2 represents diagrammatically a view of a device according to the invention in the direction of the arrow II in FIG. 1.

FIG. 3 represents diagrammatically a view of a device according to the invention in the direction of the arrow III in FIG. 1.

FIG. 4 represents diagrammatically a view of a device according to the invention in the direction of the arrow IV in FIG. 1.

FIG. 5 represents diagrammatically a view of a device according to the invention taken along the line V-V in FIG. 4.

FIG. 6 represents diagrammatically a sectional view of a device according to the invention taken along the line VI-VI in FIG. 5.

FIG. 7 represents diagrammatically a detail view of device according to the invention according to the reference VII in FIG. 3.

FIG. 8 represents diagrammatically a detail view of device according to the invention according to the reference VIII in FIG. 2.

FIG. 9 represents diagrammatically a view similar to FIG. 4 of a device according to the invention in a manipulation position.

FIG. 10 represents diagrammatically a view of a device according to the invention taken along the line X-X in FIG. 9.

FIG. 11 represents diagrammatically a sectional view of a device according to the invention taken along the line XI-XI in FIG. 10.

FIG. 12 represents diagrammatically a detail view of device according to the invention according to the reference XII in FIG. 10.

FIG. 13 represents diagrammatically a detail view of device according to the invention according to the reference XIII in FIG. 11.

FIG. 14 represents diagrammatically a front view of a sucker support of a device according to the invention.

FIG. 15 represents diagrammatically a perspective view of the sucker support from FIG. 14.

### DETAILED DESCRIPTION OF THE INVENTION

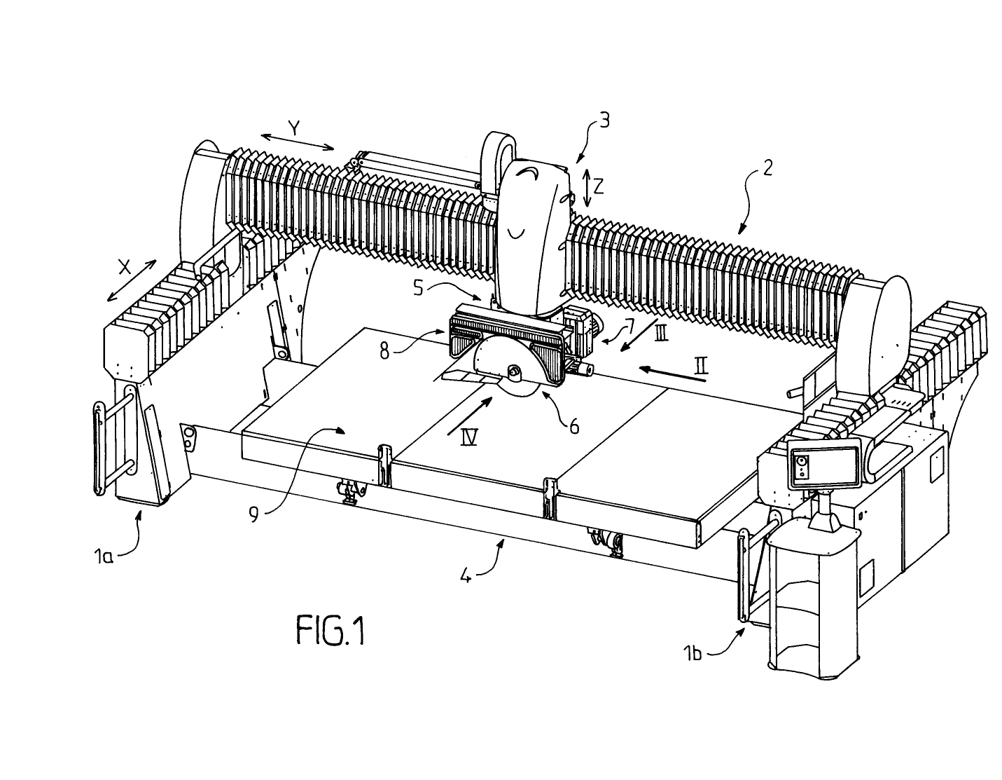

Referring to FIGS. 1 to 15, elements that are identical or functionally equivalent are identified by identical numbers or references.

In FIG. 1, a numerically controlled machine with a plurality of axes of movement includes a lateral base (1a) and a lateral base (1b) connected to each other by a central beam (2) carrying a carriage (3).

The lateral bases (1a, 1b) support the axes of movement in translation in a first direction (X). The central beam (2) supports the axis of movement in the direction (Y).

The carriage (3) is movable in the direction (Z).

The structure defined by the lateral bases (1a, 1b) and the central beam (2) is a gantry structure overlying a central space in which is disposed a support structure (4) including rails connected to the lateral bases (1a, 1b).

The carriage (3) movable along the axis (Z) carries a machining head (5).

The machining head (5) carries laterally on either side a cutter disc assembly (6) and jigsaw means (7) for making cuts in closed corners of a part to be worked.

Manipulator sucker means (8) are mounted laterally at a distance from and above the protective casing of the cutter disc of the cutter disc assembly (6).

Thanks to the aforementioned arrangement, parts placed on a worktable (9) are accessible to the machining means mounted on the machining head (5), in particular the cutter disc assembly (6) and the jigsaw means (7).

The parts to be cut or cut out can be manipulated by the manipulator sucker means (8), in particular when these means (8) are oriented at 90° to offer up a horizontal suction surface.

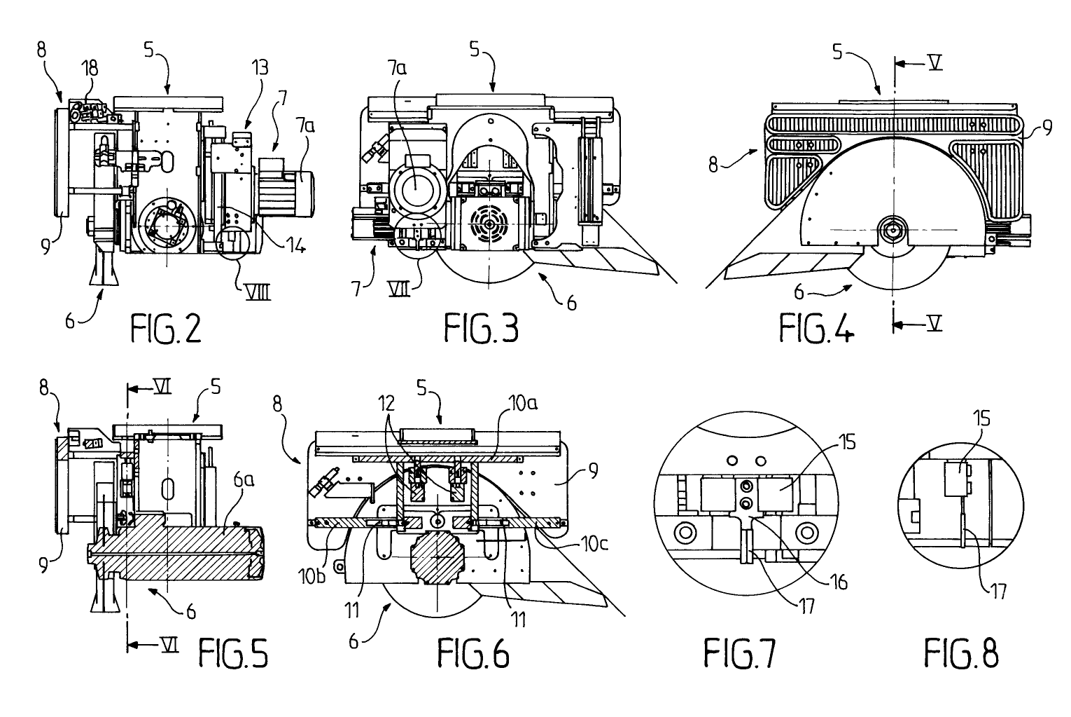

Referring to FIGS. 2 to 8, a device according to the invention advantageously consists of a head (5) carrying laterally the cutter disc assembly (6) and the jigsaw means (7).

The manipulator sucker means (8) are removably fastened to the machining head (5) to enable detachment and replacement or cleaning of the manipulator sucker means (8), depending on the type of material processed by the machine according to the invention.

The manipulator sucker means (8) are mounted laterally at a distance from and above the cutter disc assembly (6) when the device is in a cutting position.

In the stowed position of the manipulator sucker means, there is therefore entirely free access to the casing of the cutting assembly (6) and to the associated deflector, so that a cutter disc can be replaced without working on the manipulator sucker means (8).

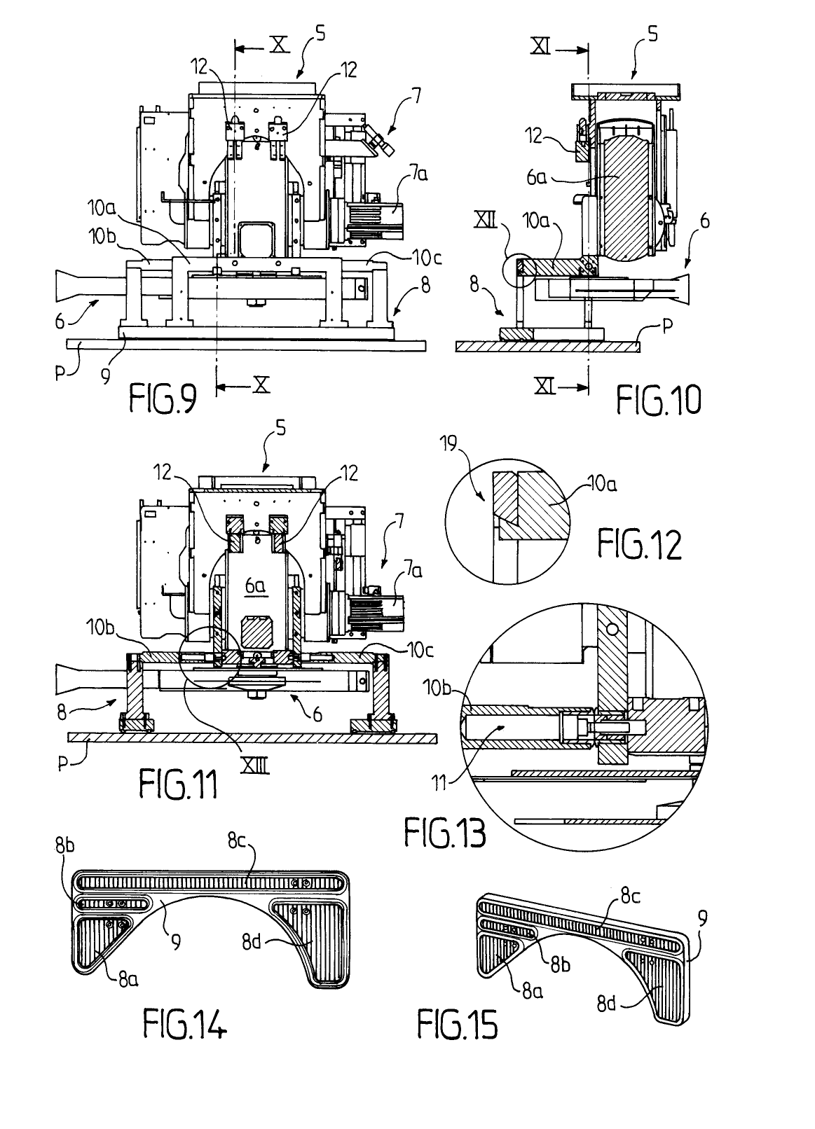

The cutter disc assembly includes the cutter disc casing, the associated deflector, the drive motor (6a) and means adapted to pivot 90° or more between a cutting position (FIGS. 2 to 8) and an inactive position (FIGS. 9 to 13).

The manipulator sucker means (8) include four suckers mounted on a common support (9) mounted on bars (10a, 10b, 10c) by means of spacers.

This common support (9) of the plurality of suckers is mounted laterally at a distance from and above the protective casing of the cutter disc (6) when the device is in the cutting position.

The bars (10a, 10b) carry at their end indexing pistons (11) that define sucker engagement indexing.

The bar (10c) cooperates with two indexing pistons (12) that define the sucker stowed position represented in FIGS. 2 to 6.

The bars (10a, 10b, 10c) connected to the support (9) enable demounting of the manipulator sucker means (8). Accordingly, the manipulator sucker means (8) can be replaced by other means (8) carrying suckers of different shapes as a function of the operations to be carried out and the contour of the parts to be manipulated.

The jigsaw assembly (7) is mounted on a sliding member (13) guided on two columns (14) so it can be moved into a position of use or a retracted position, represented in FIG. 2.

The sliding member (13) also carries the motor (7a) for driving the jigsaw, a blade-support (15) and a blade (16).

The blade (16) has a diamond-coated leading edge (17) for cutting granite or other materials of comparable hardness.

A preferred use of the device is as follows: straight or rectilinear segments are preferably through-cut using the cutter disc to ensure rapid cutting, while cutting in closed corners is advantageously carried out using the jigsaw means (7), which enables a vertical cut and corner finishing to be achieved without demounting or changing tools.

The sucker means (8) preferably include Venturi-effect suckers connected to a pneumatic unit (18) mounted in the vicinity of the top bar (10c).

Use of the jigsaw means (7) is also appropriate for cutting out parts with offsetting of the head, notably for making a cut-out from the lower face of a part to be cut out.

Referring to FIGS. 9 to 13, a device in accordance with the invention is represented in a position for manipulating a part (P) to be cut or cut out.

In the stowed position of the support (9) carrying a plurality of suckers the indexing means (12) are free, therefore allowing 90° pivoting of the cutter disc assembly and its drive motor (6a).

The part (P) is removably attached to the manipulator sucker means (8) by suction to enable the manipulator sucker means (8) to lift it, move it and put it down.

In the manipulation position of the manipulator sucker means (8), the casing of the cutter disc assembly (6) and the associated deflector are disposed laterally at a distance from and above the manipulator sucker means (8) and are not exposed to any risk of impacting on or of coming into contact with the part (P).

The bars (10a, 10b) carrying at their end the indexing pistons (11) that define the sucker engagement indexing retain the support (9) of the manipulator sucker means (8). The jigsaw assembly (7) mounted on the sliding member (13) guided on the columns (14) is preferably moved into the retracted position represented in FIG. 9 or FIG. 11.

The manipulator means (8) are attached and retained at the top by a dovetail assembly (19) and retained at the bottom by the indexing means (11) represented in detail in FIG. 13.

In this manipulation position, the suckers of the support (9) are applied to the part (P) by moving the head (5), lift or retain the part (P) by suction and then move it or slide it on the worktable (9).

After the part (P) is attached to the manipulator means (8) by suction, the part (P) is moved in a manner known in itself, preferably along the movement axes (X, Y, Z), until it reaches a required position.

Referring to FIGS. 14 and 15, the support (9) of the manipulator means (8) advantageously has four contours defining suckers of different sizes.

The invention of course encompasses a plurality of suction areas or suckers, regardless of their number, preferably of different sizes to suit different sizes or dimensions of parts to be manipulated.

In the example represented in FIGS. 14 and 15, the support (9) carries a sucker (8a) in the shape of a right-angle triangle, a short sucker (8b) of elongate shape, a long sucker (8c) of elongate shape, and a sucker (8d) of substantially trapezoidal shape, with rounded edges.

The invention described with reference to one particular embodiment is in no way limited thereto, and to the contrary covers any modification of shape and any variant embodiment within the scope of the appended claims.

1. Device for cutting granite or other hard materials, of the type including a cutter disc (6) for making cut-outs of rectilinear or curved shape, characterized in that the device includes a machining head (5) simultaneously carrying said cutter disc (6) and jigsaw means (7) for making cuts in closed corners.

2. Cutting device according to claim 1, characterized in that the device includes manipulator sucker means (8) for moving parts to be cut or parts (P) to be cut out.

3. Cutting device according to claim 1, characterized in that the jigsaw means (7) include a saw blade (16) with a diamond coating (17).

4. Cutting device according to claim 2, characterized in that the manipulator sucker means (8) are movable between a first or lateral stowed position and a second or manipulation position.

5. Cutting device according to claim 4, characterized in that the manipulator sucker means (8) include a plurality of suckers (8a-8d) mounted on a common support (9).

6. Device according to claim 5, characterized in that the common support (9) of the plurality of suckers (8a-8d) is mounted laterally at a distance from and above the protective casing of the cutter disc (6) when the device is in a cutting position.

7. Device according to claim 1, characterized in that the jigsaw means (7) include a sliding member (13) guided on two columns (14) and carrying the motor (7a) for driving the jigsaw.

8. Device according to claim 6, characterized in that the common support (9) of the plurality of suckers (8a-8d) is removably mounted on the support of the cutter disc assembly (6).

9. Device according to claim 1, characterized in that the cutter disc assembly (6) and the jigsaw means (7) are mounted laterally on either side of a machining head (5).

10. Numerically controlled machine with a plurality of axes of movement, including a device according to claim 1.

11. Cutting device according to claim 2, characterized in that the jigsaw means (7) include a saw blade (16) with a diamond coating (17).
